(19) United States
(12) Patent Application Publication
(10) Pub. No.: US 2011/0268630 A1
(43) Pub. Date: Nov. 3, 2011

(54) SAMPLE HOLDER FOR USE IN BIOLOGICAL TESTING

(76) Inventors: Sarah Janet Williams, Maidstone (GB); Douglas Mark Green, Maidstone (GB)

(21) Appl. No.: 13/143,991

(22) PCT Filed: Jan. 11, 2010
(86) PCT No.: PCT/EP10/50181

§ 371 Date: Jul. 11, 2011

(30) Foreign Application Priority Data
Jan. 12, 2009 (GB) 0900421.9

(51) Int. Cl. B01L 9/00

(52) U.S. Cl. 422/560

(57) ABSTRACT

A holder (2) is provided intended to receive one or more samples of biological fluid for subsequent processing, for example using a robotic punch. The holder has a plastics frame having a windowed portion (3), a substrate (4) for receiving the biological fluid inset within the windowed portion, a cover (7) mounted on the frame slidable between a first position spaced from but overlying the substrate and a second position revealing the substrate and a drying agent (8) positioned on the cover on that side which overlies the substrate in the first position.

### FIELD OF THE INVENTION

This invention relates to a sample holder for use in biological testing and is particularly concerned with a sample holder capable of use in conjunction with robotic sample processing devices, such as a robotic punch.

### BACKGROUND OF THE INVENTION

There is a rapid increase in the use of testing methods for both medical diagnostic and forensic use, where samples of biological fluid are captured and then submitted to further mechanical processing procedures, for example by taking a small punch of the captured material for further analysis. Previously, samples of biological material, for example blood, saliva or urine, have been collected on cards made typically of paper-based materials. An example of such a card is an FTA card (“FTA” is a registered trade mark of Whatman, part of GE Healthcare), where a paper substrate capable of receiving several, usually four, blood spots is glued between two card layers. For further processing and/or analysis, samples, suitably of 3 mm diameter, are hand punched from the cards. However, the increased use of such testing techniques has seen the introduction of robotically controlled sampling mechanisms, such as robotic punches. In order to ensure smooth and accurate throughput when using such punches, the material to be sampled must be presented to the machine taking account of several stringent requirements.

Firstly, the sample must be held sufficiently rigidly to withstand the use of a robotic punch. For example, if using a card such as that described above, any inconsistency in registration between the two layers of card can cause the punch to malfunction and the card and/or the substrate to become physically damaged. In addition, if the card is too flexible, bowing of the construction can occur before or after it is placed in the machine, causing inaccurate registration of the sample and the machine, which leads in turn to inaccurate punching and consequent inaccurate analysis results. Further problems arise in getting the biological sample to the punch in a consistently acceptable state. Thus, the sample needs to be dry at the point of contact with the punch. As the samples will have been applied to the substrate in liquid form, prolonged drying time can slow down the throughput. Furthermore, dependent on the nature of the substrate and/or the sample, there can be problems of contamination and/or hygroscopy which interfere with the punching operation.

Biological specimen collection paper sandwiched within a plastics slide mounting has been described in European Patent Publication No. 1445021. A simple sliding cover is mentioned for ensuring cleanliness of the paper during sample collection. Published U.S. patent application 2004/0126281 describes a rigid storage container into which a biological sample is sealed and subsequently withdrawn at the point of sampling by a punch. However, neither of these disclosures addresses the range of problems outlined above.

### SUMMARY OF THE INVENTION

This invention provides a holder intended to receive one or more samples of biological fluid for subsequent processing, comprising a plastics frame having a windowed portion, a substrate for receiving the biological fluid inset within the windowed portion, a cover mounted on the frame slidable between a first position spaced from but overlying the substrate and a second position revealing the substrate and a drying agent positioned on the cover on that side which overlies the substrate in the first position.

Preferably the windowed portion has a substantially rectangular window and the cover is in the form of a slide. The slide may be positioned for movement in a groove arranged substantially parallel to but spaced from one of the sides of the window, usually the shorter side. Alternatively the slide may be in the form of a sleeve moveable between open and closed positions constrained by stops provided on the frame. The window is preferably offset at one side of the support, so that, in its second position, the slide lies over a non-windowed portion of the cover. The windowed portion may have a plurality of windows revealing portions of the substrate to which the biological fluid is to be applied.

The frame can be of any suitable plastics such as an acrylic polymer. The plastics chosen will depend on the testing being carried out. In some circumstances opaque plastics may be preferred in order to protect the samples from light. In other circumstances, it may be convenient to employ transparent materials. The frame may be conveniently constructed from two formed sheets of plastics formed with mating indentations and recesses so that the two sheets can be snapped together with the substrate sandwiched in between.

The frame and/or the substrate is preferably provided with means for physical and /or optical registration with a processing device to be used with the holder. Thus the frame may have at least one corner cutaway for physical registration into a slot in the processing device. Alternatively, or in addition, the frame or the substrate, or both, may contain printing for optical registration with the processing device. As an alternative, registration may be effected by controlling the window size so as to define those portions of the substrate to which the biological fluid is to be applied, in which case the position of the windows and the applied fluid will serve to effect registration.

The registration means will preferably also include means for actuating the cover from its first position to its second position where the substrate is revealed. This processing device will normally be a robotic machine, such as a punch, for example a machine such as the Perkin Elmer 1296-091 Wallac AutoPuncher (“Wallac AutoPuncher” is a registered trade mark). However, the holder can be used with a hand punch or with other sampling devices.

The substrate is intended to receive samples of a wide range of biological fluids such as blood, saliva and urine. Such samples find widespread use in medical screening programme, drug testing and forensics. The nature of the substrate will of course depend on the nature of the biological fluid and the intended downstream processing of the sample. Typical substrates are cellulosics, woven and non-woven porous polymers and glass microfiber. An example is Cellulose 31ETF, available from Whatman, part of GE Healthcare. It is common for such substrate sheets to contain printed spots, for example four, into which aliquots of the biological fluid, e.g. blood, are placed. The processing machine preferably takes a punch of a predetermined size, e.g. 3 mm diameter, from each spot for subsequent analysis and comparison. While the substrate will normally only be punched once, it is possible for the cover to be repositioned over the window and the holder stored for later re-use.

The holder is preferably, though not necessarily, sized for use with conventional automated processing machines. A suitable size is approximately that of half a 96 well plate. The substrate sheet is usually approximately the same size as the holder.

Examples of substrates, with suitable coatings intended for DNA sampling and further processing are given in U.S. Pat. No. 5,496,562 and U.S. Pat. No. 5,939,259. Such substrates are commercially available in the form of FTA Cards (“FTA” is a Registered Trade Mark).

The drying agent may be a layer of desiccant applied to that side of the cover which overlies the substrate in the first position. It can be any suitable desiccant which can be readily applied to the cover. Examples of such desiccants are silicas, zeolites, calcium chloride and clays. Alternatively, a sheet of any material capable of exerting a drying effect when overlying the substrate may be used, for example a sheet of oven dried 31ETF mounted on the cover. It will be appreciated that the drying layer must be arranged so that it does not come into contact with the substrate but that it is in sufficiently close proximity to exercise a rapid and effective drying of the biological fluid after it is applied to the substrate and to protect the biological fluid and/or the substrate and any coating thereon, from any tendency during storage and before sampling to become hygroscopic. So as not to deactivate the drying agent too soon if the holders are stored before use, the dessicant is preferably covered by a protection strip, preferably of foil, removable at the time of application of the biological fluid. For this purpose, the protection strip may be initially arranged over the layer of drying agent with a projecting pull strip provided so that the layer can be peeled back at the point of sample application to the substrate.

It will be appreciated that the presence of the drying layer close to the biological fluid means that holders can be processed very quickly without the need for prolonged drying periods, for example in the atmosphere of the laboratory, or in the field. Therefore, in addition, the danger of sample contamination is reduced as well as the overall processing time. Quick drying of biological fluids, especially whole blood, is advantageous in preserving the blood samples in their optimum condition.

### BRIEF DESCRIPTION OF THE DRAWINGS

FIG. 1 shows a top perspective view of the holder with the cover in its second (open) position;

FIG. 2 shows the holder of FIG. 1 with the cover in its first (closed) position;

FIG. 3 is a side view of the holder as shown in FIGS. 1 and 2;

FIG. 4 is a top plan view of the holder with the cover open;

FIGS. 5 and 6 are front views of a modified holder with the cover in the first (closed) and second (open) position respectively;

FIG. 7 is a side view of the holder as shown in FIG. 6; and

FIG. 8 is an exploded view of the holder shown in FIGS. 5 to 7.

### DETAILED DESCRIPTION OF THE INVENTION

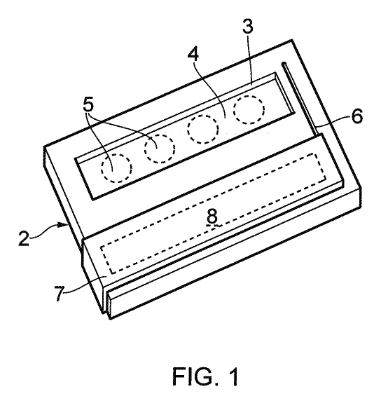

One form of holder in accordance with the invention is shown in FIGS. 1 to 4. The holder has a rectangular frame 2, constructed of plastics material such as an acrylic polymer with a rigidity sufficient to withstand handling within a robotic punch such as the 1296-091 Wallac AutoPuncher (“Wallac AutoPuncher” is a registered trade mark). At one side of frame 2, there is a window 3, within which is positioned a sheet of a substrate 4. The substrate 4 may be positioned in the frame 2 by any suitable means, for example by forming frame 2 in two sheets (not shown) which are snapped together to sandwich the substrate 4 which is of dimensions slightly larger than that of window 3. Substrate 4 may be of FTA paper (“FTA” is a registered trade mark” of Whatman, part of GE Healthcare) and formed with four printed circles 5 to which the sample, for example of blood, is to be applied. The frame 2 is dimensioned so that the window takes up only approximately half of the frame.

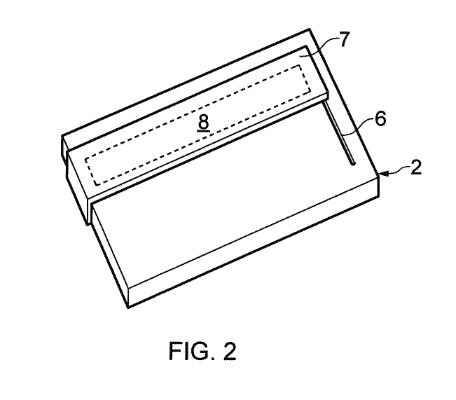

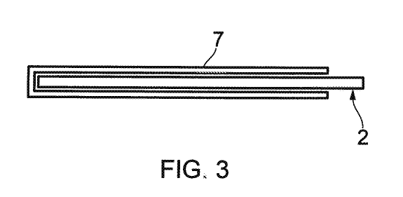

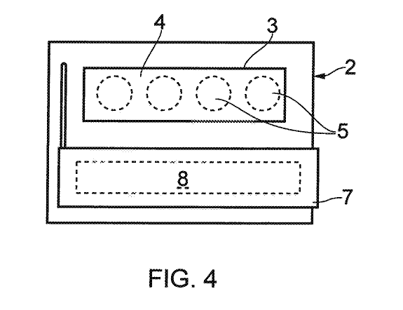

Along one side of the frame is a groove 6, which receives a mating ridge (not shown) on the underside of a slide 7. As can be seen from FIG. 3, the slide 7 extends with a U-shaped cross section around the frame 3 and can move along the groove 6 between a closed position, as shown in FIG. 2 and an open position as shown in FIGS. 1 and 4. In the open position, the substrate 4 with its circles 5 is fully visible. In the closed position, the substrate is fully covered, although it will be seen from FIG. 3 that the slide 7 lies proud of the frame 3 and consequently, is clear of the substrate 4. The underside of slide 7 carries a slim silica pouch 8 (shown in dotted lines). This can initially be protected by a layer of foil (not shown) which can be peeled away immediately before use, for example by means of a projecting pull tab.

Suitable dimensions for the frame are approximately 85 mm×53 mm, with a window of 61 mm×19 mm spaced about 10 mm from the top edge of the frame. This will give a holder which is approximately the size of half a 96 well plate. However it will be appreciated that the holders can be scaled up or down to any suitable size for the processing device with which they are to be used.

Before use, the holders may be stored in the closed position with the silica pouches protected so that they do not become used up too soon. When required, the slide 7 is opened, the foil protection removed and the sample, e.g. blood, spotted into the circles 5. The frame and/or the slide may bear physical and/or electronic codes and labels to identify the samples. The slide 7 is immediately closed and the silica completes the drying of the samples while the slide protects them. Each holder is then registered in turn with the robotic punching machine which, preferably, actuates a mechanism to push back the slide and allow accurate access by the punching mechanism to the dry spots.

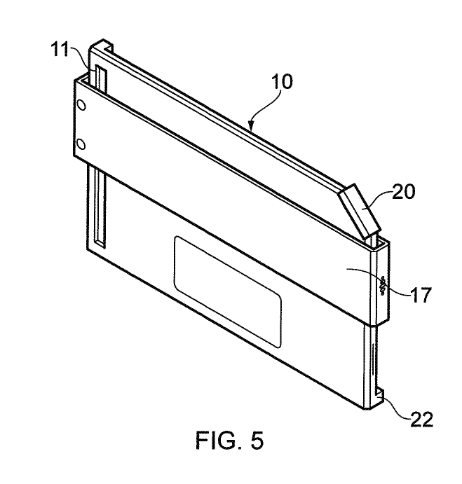

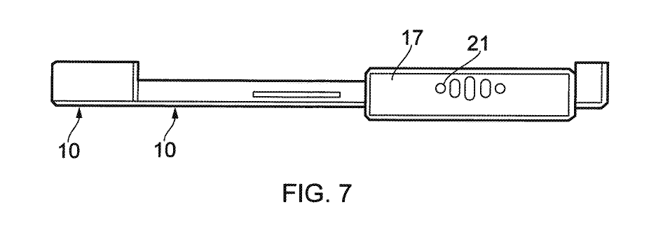

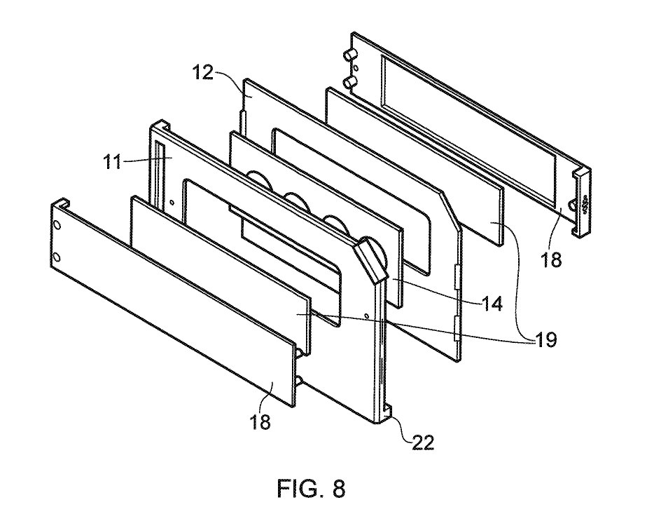

A modified holder construction is shown in FIGS. 5 to 8. The holder has a rectangular frame 10 composed of a windowed front part 11 and a mating windowed rear part 12, best seen in FIG. 8, which have been snapped fitted together to hold within the window 13 a sheet of substrate 14 as previously described in connection with FIGS. 1 to 4. The frame 10 is dimensioned so that the window takes up only approximately half of the frame.

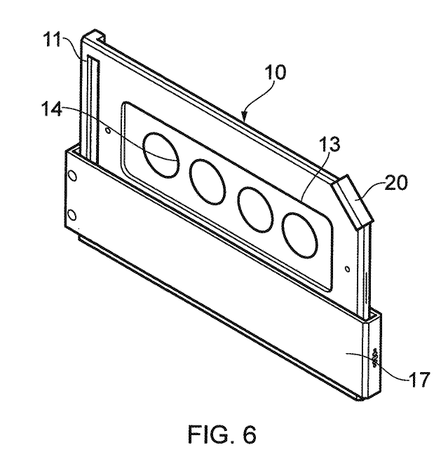

A slide 17, constructed of two snap fitted parts 18, best seen in FIG. 8, is held for sliding movement on the frame 10 between a closed position as shown in FIG. 5 and an open position as shown in FIG. 6. Movement of slide 17 is limited by a chamfered and thickened corner 20 provided on frame 10 and rear projecting feet 22, which also assist in spacing the holder from a bench surface if required.

Raised indentations 21 may be provided on the slide 17 to assist in its ready movement between the open and closed positions. In the closed position, labelling information is clearly visible. In the open position, the substrate is visible and ready to receive samples within the printed circles or, if the samples are already in place, to be entered into a device, such as a robotic punching machine, for further processing of those samples.

The underside of each part 18 of slide 17 carries a layer 19 of suitable desiccant. The desiccant may be in the form of a pouch adhered or snap fitted by any suitable means to the parts 18 so, that in use, it remains spaced from the substrate 4. It will be appreciated that the pouch can be replaced by any suitable layer which exhibits desiccant properties.

What is claimed is:

1. A holder intended to receive one or more samples of biological fluid for subsequent processing, comprising a plastics frame having a windowed portion, a substrate for receiving the biological fluid inset within the windowed portion, a cover mounted on the frame slidable between a first position spaced from but overlying the substrate and a second position revealing the substrate and a drying agent positioned on the cover on that side which overlies the substrate in the first position.

2. The holder of claim 1, wherein the windowed portion has a substantially rectangular window and the cover is in the form of a slide positioned for movement in a groove arranged substantially parallel to but spaced from one of the sides of the window.

3. The holder of claim 1, wherein the slide is in the form of a sleeve moveable between open and closed positions constrained by stops provided on the frame.

4. The holder of claim 1, wherein the window is offset at one side of the support, so that, in the second position, the slide lies over a non-windowed portion of the cover.

5. The holder of claim 1, wherein the frame comprises two formed sheets of plastics formed with mating indentations and recesses which snap the two sheets together with the substrate sandwiched in between.

6. The holder of claim 1, wherein the drying agent is a layer of desiccant applied to that side of the cover which overlies the substrate in the first position.

7. The holder of claim 6, wherein the desiccant comprises one or more materials selected from silicas, zeolites, calcium chloride and clays.

8. The holder of claim 6, wherein the layer of desiccant is covered by a protection strip removable at the time of application of the biological fluid.

9. The holder of claim 8, wherein the protection strip is of foil.

10. The holder of claim 1, wherein the substrate is a sheet of cellulosic material, woven or non- woven porous polymer, or glass microfiber.

11. The holder of claim 1, wherein registration means are provided for physical and/or optical registration with respect to a processing device to be used with the holder.

12. The holder of claim 11, wherein the registration means includes means for actuating the cover from its first position to its second position to reveal the substrate.

13. The holder of claim 11, wherein the registration means are adapted for registration with a robotic punch.
